(19) United States
(12) Patent Application Publication
(10) Pub. No.: US 2002/0188372 A1
(43) Pub. Date: Dec. 12, 2002

(54) Method and system for computer aided garment selection

(76) Inventors: Kenneth M. Lane, Santa Cruz, CA (US); Karen A. Stewart, Aptos, CA (US)

Correspondence Address: NxView Technologies, Inc., 2000 Regency Park, Suite 500, Cary, NC, 27511, US

(21) Appl. No.: 09/852,573

(22) Filed: May 10, 2001

(51) Int. Cl. G06F 19/00; G06F 7/66

(52) U.S. Cl. 700/130; 700/132; 700/137

(57) ABSTRACT

A method is provided for indicating a fitting condition of a garment on a virtual model of a person. One or more fitting points and corresponding measurements of the garment relevant for examining the fitting condition of the garment on the virtual model are identified first. One or more fitting preferences for the garment are also indicated. Poor fit locations on the virtual model are then highlighted after examining the person's fitting preferences against the measurements of the fitting points. The person can use the virtual model for examining whether the garment fits well in order to make a purchase decision in an interactive remote shopping session.

### BACKGROUND

The present invention relates generally to computer graphics and remote shopping, and more particularly, to a method and system for interactively selecting and fitting virtual garments on a customized graphics character.

Current technology provides computer applications for interactive remote shopping, where a shopper selects one or more garments from an online catalog. These garments are then “placed on” a virtual model such as a customized graphics character (“mannequin”) simulating the shopper to visualize himself/herself wearing the selected garments. The shopper is then allowed to choose to purchase the garments by moving them to a “shopping cart,” or to reject any unfit garments. The process is repeated until the shopper finds one or more garments that fit him/her well, and “checks out” by providing shipping and payment information. The garments are then packaged and shipped from the merchant to the shopper.

These interactive computer applications for remote shopping often use a network environment such as the Internet for connecting a computer used by the shopper to a computer system owned by the merchant. Once this connection is made, applicable computer software programs running on the merchant's computer allows the user to see his choices on his own computer display, and to interact with the programs in various ways. This interactive process also allows for the merchant's computer system to be accessed by more than one shopper. In addition, the software at the merchant's computer system is capable of collecting and maintaining data about each user, and further protects the data by requiring a unique user name and password to each user before he can access the maintained data. In this way, data entered once may be used later in the same or subsequent shopping session. Typical information saved is name, shipping and billing addresses, payment information, etc.

One part of the saved information is personal measurement information which may include height, weight, waist and chest measurements, etc. With the measurement information, the merchant's computer system is able to assist the shopper in selecting garments. In addition, the measurement information, along with other information provided by the shopper, can also be used to customize or personalize the design of the mannequin. For example, the mannequin can be male or female, with a particular height and weight, and have a particular hairstyle or skin color. While viewing the presented mannequin, the shopper selects a style of garment, and the merchant's computer system can suggest size or color that best suits the shopper. Selected garments are then dressed on to the personalized mannequin which give a “virtual reality” effect indicating how well the shopper would look if he/she were dressed in the selected garments.

Remote shopping is quite different from in-store shopping in many ways. For example, in-store shopping experience conventionally asks the shopper to select one preferred size, e.g., “medium,” “extra large,” “petite,” or standard size label such as “42 regular.” But, even with this standard size structure, a shopper in a store may still take several garments of difference sizes to try on in order to find one that fits best. No existing on-line shopping system provides such an opportunity to try on garments. In addition to the choice of sizes, each shopper may have a preference for how garments fit, whether tight or loose or “baggy.”

To complicate the situation, each manufacturer of a garment is free to define the exact measurements of a garment by size. In a normal situation, the manufacturer keeps the dimensions of each size constant across a broad range of garments and garment styles made by it. For example, all “large shirts” garments made by a particular designer are of approximately the same dimensions. However, the garments may still be of different sizes if they are designed by different designers and even if they are marked as the same size. Thus a shopper may find the “large” size of one manufacturer the proper size for him while requiring an “extra large” size of another manufacturer.

What is needed is, in an interactive remote shopping session, a visual indication of how well a selected garment fits a personalized mannequin based on both the shopper's fit preference and the manufacturer's garment measurements.

### SUMMARY

A method and system for indicating a fitting condition of a garment on a virtual model (“mannequin”) of a shopper helps the shopper make a purchase decision in an interactive remote shopping session. In one embodiment, the virtual model is depicted by computer graphics software resembling the shopper and graphically formed by a plurality of interconnected vertices. The shopper utilizes the virtual model for examining whether the garment fits well thereon. First, one or more fitting points and corresponding measurements of the garment relevant for examining the fitting condition of the garment on the virtual model are identified. It is understood that the fitting points vary based on the type of the garment selected. Then, one or more shopper's fitting preferences for the garment are indicated. The fitting preferences indicate, for example, whether the shopper prefers the garment to be tight, snug, normal, loose, or baggy. Poor fit locations on the virtual model are identified after examining the shopper's fitting preferences against the measurements of the fitting points. The poorly fitting regions of the mannequin will be set to a readily identifiable contrasting appearance so that these regions will be distinctively highlighted. In one example of the present invention, the poorly fit locations are highlighted by adjusting the color affected vertices to a readily identifiable contrasting color. By viewing the highlighted locations on the clothed mannequin/avatar, the shopper decides whether the selected garment looks good on himself/herself and makes a purchase decision thereafter.

### BRIEF DESCRIPTION OF THE DRAWINGS

FIG. 1 is a “wiremesh” mannequin showing the vertices and the lines connecting them to form the mesh.

FIG. 2a is the same mannequin in FIG. 1 dressed by applying texture maps to give the appearance of wearing selected garments.

FIG. 2b is the “skeleton” view of the mannequin in FIG. 1.

FIG. 3 is the same mannequin in FIG. 2 with poor fit spots highlighted according to one example of the present invention.

FIGS. 4 and 5 illustrate the use of spectral factor for changing the graphical presentations of a simple example according to one example of the present invention.

### DETAILED DESCRIPTION

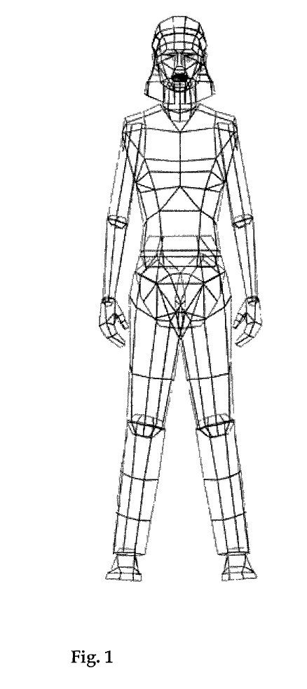

Referring to FIG. 1, the reference numeral 10 designates, in general, a mannequin, or “avatar.” An avatar is usually composed of a mesh of points or vertices connected among themselves forming polygons, typically triangles. The “wiremesh” mannequin 10 has many points and lines to form various polygons 12, thereby giving a general description of a man or woman. These polygons are then provided with color and pattern information, referred to as a texture map. The texture map allows the polygons 12 to appear as a piece of fabric containing various materials, colors and patterns. In a normal situation, the number of polygons 12 and the quality of the texture maps greatly affect the realistic appearance of the mannequin 10.

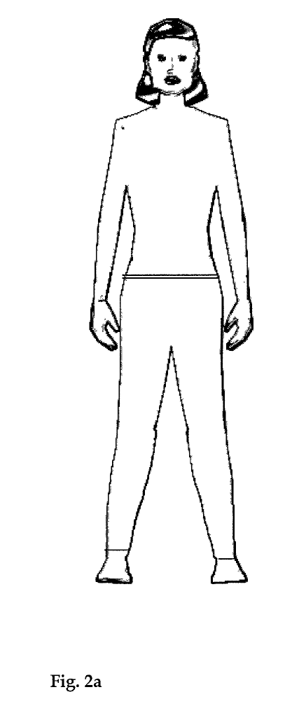

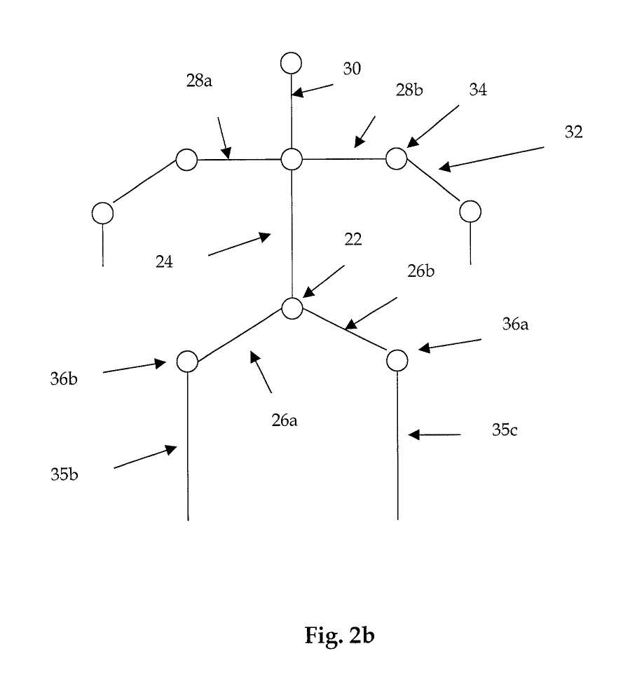

Referring now to FIG. 2a, the mannequin 20 of FIG. 1 has texture maps applied thereon. For the mannequin, the polygons of the mesh can be colored with texture maps to give the appearance of having clothes on the body. For instance, the legs are textured with trousers, and the torso with a shirt, etc. FIG. 2a only roughly shows some patterns applied indicating the application of various texture maps, but it is understood that due to lighting conditions, the appearances of various body parts differ based not only on color, but also on other factors such as light shadings, positions of the body parts, etc.

Referring to FIG. 2b, the “skeleton” of the mannequin is shown. As it is known, for programming purposes, this mannequin is viewed and represented as a tree of interconnected nodes to indicate the relations between the nodes, where some of the nodes represent joints of the body. The root node 22 of the tree usually represents the center of the mannequin, typically at the center of the pelvis. The children nodes of each joint node may represent the bones connected to the joint. For example, the spine 24, and the left and right upper legs (26a and 26b) are formed by children nodes of the root. The two collarbones 28a and 28b and the neck 30 are children of the spine 24, etc. Similarly, although not shown, the torso is associated relative to the spine, and the hips and thighs are associated relative to the upper leg bones, etc.

The vertices of the mesh of the mannequin have their locations defined in a coordinate system relative to their related bone. The location is typically given as an x-, y-, and z- coordinate from the “starting point” of the bone, whereas the starting point of a bone is an end point relatively closer to the origin of the mannequin. Therefore, the starting point of the left upper arm 32 is the point 34 where it joins the collarbone 28b, and similarly, the starting point of each lower leg (35b or 35b) is the knee (36a or 36b). The same rules and conventions apply to the entire body.

The mesh is also given other characteristic values that modify the appearance of the texture applied. These are typically called “material characteristics” and represent how the surface of an object will appear under a predetermined lighting condition. Common characteristics include “diffuse”, “ambient”, “spectral”, and “specular” colors. The diffuse factor is the primary shading color. Ambient factor refers to the color of the object when not directly illuminated by light. The spectral factor refers to a color that is blended in regardless of light (e.g., a tint). For example, the specular factor determines the color given to shiny reflections on the object.

By altering the material characteristics of some regions of the clothing mesh being worn by the shopper's avatar, locations of improper fit can be highlighted. Highlighting can consist of a change in color (for instance, a red tint for too tight, and green for too loose). Or a highlight can be indicated by drawing parts of the mesh with a special texture pattern (e.g., small circles for too tight and small squares for too loose). Thus, a shopper can readily see the areas where a particular size of a piece of clothing will be overly or uncomfortably tight or loose.

When used in a current computer application for remote shopping, a mannequin is constructed to represent a virtual image of the shopper. The personal measurement information is used to locate the positions of the vertices such that the size and shape of the mannequin is close to the shopper's physical body. When articles of clothing are selected, the textures and/or geometry which represent the shape, material, color and pattern of the selected garments are used to color the polygons of the mannequin or wrapped around the mannequin resulting in a realistic appearance of the shopper wearing the selected garments.

It is understood that the effectiveness of an Internet shopping process relies on how close the mannequin can be customized toward the shopper's actual measurements, and how much applicable software can demonstrate whether the selected garments fit well with the mannequin. Only when the shopper can comfortably tolerate the difference between what he/she sees on his computer display and the actual garments purchased and shipped to his hands, the shopper will take advantage of the remote shopping experience. On the other hand, if the representation of the garment when dressed on the mannequin is in any way unrealistic, the shopper may be dissatisfied when the actual garment arrives, and reject the garment.

It is an objective of the present invention to provide an accurate indication of whether a selected garment fits the shopper well. There are generally three main steps in a process leading to such a determination of fitting conditions. First, garment measurements are identified, then the shopper's fit preference is considered. With this information, a fitting condition can then be accurately indicated to the shopper.

Garment Measurements

In addition to a conventional marking of “Small,” “Medium,” or “Large” in size, each garment is assigned one or more supplemental measurements which will be used to determine the fitting condition. As to how many supplemental measurements and where they are, is dependent on the type of garment. For example, trousers and slacks would have supplemental measurements for waist, hips, inseam, and rise (the difference between inseam and outseam lengths). Similarly, shirts would have neck size, chest, arm, and shoulder measurements, etc. These supplemental measurements would be saved in a computer database designated for storing such measurements for a multitude of garments. When a garment is selected by its type, color, and (conventional) size, the type and size information is used to retrieve the supplemental measurement information.

It is assumed in the following examples, for illustration purposes, that the shopper has selected a shirt in the remote shopping session although it is understood that similar processing will be done for any type of garment.

In one example of the present invention, it is assumed that the following information in Table 1 is saved in the computer database.

TABLE 1
Garment measurements

| Garment Style | | | |
|---|---|---|---|
| And Size | Neck Size | Chest Size | Sleeve Length |
| Oxford Small | 14 | 40 | 34 |
| Oxford Medium | 15 | 42 | 35 |
| Oxford Large | 16 | 44 | 36 |
| Rugby Small | N/A | 41 | 35 |
| Rugby Medium | N/A | 43 | 36 |
| Rugby Large | N/A | 45 | 37 |

The number of measurements for different garment types or styles may vary as a graphic designer considers appropriate. For example, in Table 1 above, since the neck of the “Rugby” shirt is not closed, there is no measurement needed. Each measurement provided will be checked against the size of the mannequin when the garment is selected. That is, the exterior of the mannequin can be used to obtain the exact size of each body part, and it is further used to be compared to the dimensions of the selected garments.

Fit Preference

The fit preference information is another type of supplemental information required from the shopper for better identifying his/her fitting condition with a particular selected garment. The shopper may provide the fit preference information along with other personal information for his/her selections, or he/she may provide such preference on a garment by garment basis. For instance, his fit preference for an Oxford shirt may be “snug” or “normal,” while the fit preference for a Rugby shirt may be “loose” or “baggy” For convenience sake, the shopper would provide a default fit preference value for each type of garment, which would be used for all different styles of the garment of a same type. For instance, the shopper may prefer jeans to be tight, but blouses to be loose. This default value can be used automatically unless a change is otherwise indicated by the shopper in the shopping session.

Fitting Condition Determination

The most important feature for determining the fitting condition is to show the shopper the locations of the unfit or poor fit part of the garment on the mannequin.

Each garment is applied to the mannequin to see if there are any locations (e.g., vertices) that indicate incorrect fit. In other words, after the supplemental measurements of the garment are compared to the measurements of the mannequin, the difference between them is again compared against one or more predetermined threshold values based on the shopper's fit preference. Table 2 below contains a set of these threshold values.

TABLE 2

| | Neck | Waist | Chest |
|---|---|---|---|
| Too Tight | <−0.5 | <−1.0 | <−1.0 |
| (poor fit indicated) | | | |
| Tight | −0.5 to −0.25 | −1.0 to −0.5 | −1.0 to −0.25 |
| Snug | −.25 to +.25 | −.5 to +.5 | −.25 to +.5 |
| Normal | +.25 to +.75 | +.5 to +1.5 | +.5 to +1.0 |
| Loose | +.75 to +1.5 | +1.5 to +3.0 | +1.0 to +3.50 |
| Baggy | +1.5 to +3.0 | +3.0 to +5.0 | +3.5 to +6.0 |
| | (or >+1.5) | (or >+3.0) | (or >+3.5) |
| Too Baggy | >+3.0 | >+5.0 | >+6.0 |
| (poor fit indicated) | | | |

In Table 2, the threshold values are shown for each of the five fitting preferences for three supplemental measurements (i.e., waist, neck, chest). In practice, this table could include as many columns as needed for possible fitting points inspected and as many rows as needed for corresponding fitting preferences. The entries in each cell are tolerance values (e.g., the plus or minus numeric values) which would be acceptable as a proper fit for the shopper. As Table 2 shows, it is generally a rule that a tighter fit has lower tolerance values. For example, if a garment has a neck measurement of less than −0.5, it would be highlighted as a poor fit, while a baggy fit should have a bigger tolerance. Consistent with this logic, a baggy fit should either only have a minimum tolerance value so that any measurement difference greater than a predetermined number would be considered a proper fit, or a merchant can set an upper limit to indicate when the garment of a particular style gets too “baggy” with respect to the mannequin.

If the threshold values are breached, the corresponding locations or vertices are indicated. This fitting condition determination process is done throughout the mannequin, and at the completion of this process, improper fit locations will be identified if there are any. The exact vertices of the mannequin where the improper fitting conditions occur are located and identified. For example, if poor fitting conditions around the neck are determined, corresponding vertices around the neck are clearly identified.

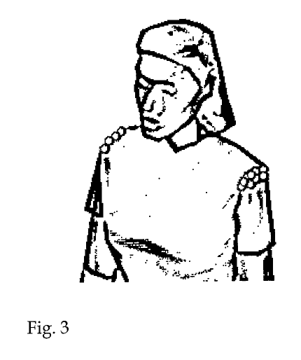

To “bring out” these poor fitting locations, one example of the present invention uses the spectral factor to highlight the fitting condition on the mannequin. It is also contemplated that other presentations can be done such as applying a different color to the poor fitting locations on the mannequin, applying a different shading pattern, or pinpointing the locations by labeling symbols such as arrow pointers or finger pointers. FIG. 3 is the mannequin 20 of FIG. 2 showing poor fit spots 40 and 42 around the shoulder area according to one example of the present invention as illustrated above. In this particular example, the shoulder areas 40 and 42 are considered improperly fit and are shown with “bubbles” indicating that the area is too tight.

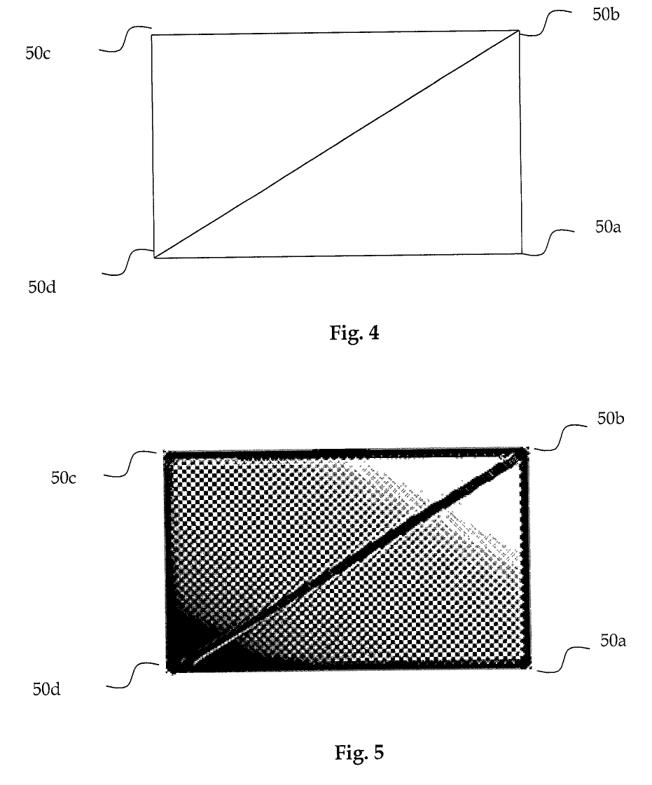

Referring to FIG. 4, a small portion of the mannequin is shown and magnified, wherein the four corner points (50a-50d) represent general vertices which, along with the lines connected among them, define two polygons, or more precisely in this case, triangles. As shown in this example, the spectral factors for the four vertices are all set at a predetermined number such as zero. Therefore the color and shading of these two triangles are evenly spread.

If the spectral factor for a vertex is set to a non-zero value, the color of the polygons adjacent or around the vertex changes gradually by blending the color together with the colors defined by other vertices. Referring to FIG. 5, the same polygon of FIG. 4 is shown but with the spectral factor for the lower left vertex 50d altered to another predetermined value (e.g. a large non-zero value) to give the graphical effect as shown. The texture of the area close to the altered mesh vertex is affected (e.g., becomes darker). The blending effect extends to the upper left vertex 50c while the vertices of the upper and lower right corners 50a and 50b are affected very little. Thus by adjusting the spectral factors, specific vertices and adjacent polygons can be highlighted. Due to the fact that the graphical effect of blending can not be illustrated clearly by black and white color, FIG. 5 is illustrated with the assistance of various different patterns with each of them overlapping on one another.

In another example of the present invention, the shopper has a choice of selecting a few key fitting points instead of examining all the vertices on the mannequin for the fitting condition. Consequently, certain areas are irrelevant as far as the shopper is concerned for trying the garment on the mannequin.

In another example of the present invention, the shopper can specify a few key vertices on the mannequin for comparing to corresponding vertices of the garment imposed thereon. For example, the shopper can specify the high points for the shoulders of the garment where the sleeves join the center piece of the garment. At the same time, the same set of vertices on the mannequin body can he highlighted or illustrated so that the shopper can see the distance difference between these two sets to determine the fitting condition.

The present invention thus provides an improved method for interactive shopping. The shopper's three dimensional image is graphically presented to fit the garment the shopper selects, and allows the shopper to see a close-to-reality effect of being dressed in the selected garment. It also highlights points on the graphically presented garments where the fit does not match the shoppers declared fit preference, and thereby helps the shopper to make a better purchase decision.

The above disclosure may provide many different embodiments, or examples, for implementing different features of the invention. Specific examples of components and processes are described to help clarify the invention. These are, of course, merely examples and are not intended to limit the invention from that described in the claims.

While the invention has been particularly shown and described with reference to the preferred embodiment thereof, it will be understood by those skilled in the art that various changes in form and detail may be made therein without departing from the spirit and scope of the invention, as set forth in the following claims.

What is claimed is:

1. A method for indicating a fitting condition of a garment on a virtual model of a person, the method comprising:
identifying one or more fitting locations and corresponding measurements of the garment relevant for examining the fitting condition of the garment on the virtual model;
indicating one or more person's fitting preferences for the garment;
comparing the measurements at the identified fitting locations of the garment with those at the same locations on the virtual model taking into consideration the indicated fitting preferences; and
presenting at least one poor fitting location if the comparison indicates an intolerable difference, the intolerable difference being determined by a predetermined tolerance range,
wherein the virtual model is graphically formed by a plurality of interconnected vertices to resemble the person, and wherein the person uses the virtual model thus constructed for examining whether the garment fits well in order to make a purchase decision in an interactive remote shopping session.

2. The method of claim 1 wherein the fitting locations vary based on the type of the garment.

3. The method of claim 1 wherein the fitting preferences vary based on the type of the garment.

4. The method of claim 1 wherein the fitting preferences indicate whether the person prefers the garment to be tight, snug, normal, loose, or baggy.

5. The method of claim 1 wherein the step of presenting further includes adjusting a color of vertices at the poor fitting locations.

6. The method of claim 1 wherein the step of presenting further includes tuning a spectral factor relating to the vertices to highlight the poor fitting locations.

7. The method of claim 1 wherein the step of presenting further includes pinpointing the poor fitting locations by a labeling symbol external to the virtual model.

8. The method of claim 1 wherein the step of presenting further includes identifying one or more key fitting vertices at the fitting locations on the virtual model as well as corresponding key fitting vertices on the garment, wherein the locations of the key fitting vertices of the garment are compared with those on the virtual model after the garment is imposed thereon.

9. A system for indicating a fitting condition of a garment on a virtual model of a person, the system comprising:
means for identifying one or more fitting locations and corresponding measurements of the garment relevant for examining the fitting condition of the garment on the virtual model;
means for indicating one or more person's fitting preferences for the garment;
means for comparing the measurements at the identified fitting locations of the garment with those at the same locations on the virtual model taking into consideration the indicated fitting preferences; and
means for presenting at least one poor fitting location if the comparison indicates an intolerable difference, the intolerable difference being determined by a predetermined tolerance range,
wherein the virtual model is graphically formed by a plurality of interconnected vertices to resemble the person, and wherein the person uses the virtual model thus constructed for examining whether the garment fits well in order to make a purchase decision in an interactive remote shopping session.

10. The system of claim 9 wherein the fitting locations vary based on the type of the garment.

11. The system of claim 9 wherein the fitting preferences vary based on the type of the garment.

12. The system of claim 9 wherein the fitting preferences indicate whether the person prefers the garment to be tight, snug, normal, loose, or baggy.

13. The system of claim 9 wherein the step of presenting further includes adjusting a color of vertices at the poor fitting locations.

14. The system of claim 9 wherein the step of presenting further includes tuning a spectral factor relating to the vertices to highlight the poor fitting locations.

15. The system of claim 9 wherein the step of presenting further includes pinpointing the poor fitting locations by a labeling symbol external to the virtual model.

16. The system of claim 9 wherein the step of presenting further includes identifying one or more key fitting vertices at the fitting locations on the virtual model as well as corresponding key fitting vertices on the garment, wherein the locations of the key fitting vertices of the garment are compared with those on the virtual model after the garment is imposed thereon.
